(19) United States
(12) Patent Application Publication
(10) Pub. No.: US 2026/0299131 A1
(43) Pub. Date: Oct. 1, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: KEI OISHI, TOKYO (JP); TOSHIO YAMAZAKI, TOKYO (JP); YASUHIRO SUTOU, TOKYO (JP)

(21) Appl. No.: 19/477,797

(22) PCT Filed: Apr. 15, 2024
(86) PCT No.: PCT/JP2024/014973

§ 371 Date: Oct. 23, 2025

(30) Foreign Application Priority Data
May 2, 2023 (JP) 2023-076243

(51) Int. Cl. G01S 17/89; G01S 7/481; G01S 7/484; G01S 17/86; G06T 7/73

(52) U.S. Cl. CPC G01S 17/89; G01S 7/4817; G01S 7/484; G01S 17/86; G06T 7/73; G06T 2207/10028

(57) ABSTRACT

The present technology relates to an information processing apparatus, an information processing method, and a program which enable calibration of a positional relationship between a three-dimensional sensor and a camera to be easily executed with high accuracy. The information processing apparatus of the present technology includes an irradiation control unit that controls an irradiation timing of measurement light of a three-dimensional sensor; a corresponding point detection unit that detects, in a camera image acquired by a camera, a corresponding point that corresponds to an observation point detected using the measurement light by the three-dimensional sensor; and a correction unit that corrects a parameter indicating a positional relationship between the three-dimensional sensor and the camera on the basis of a position of the observation point in a predetermined three-dimensional coordinate system and a position of the corresponding point in a two-dimensional coordinate system of the camera image. The present technology can be applied to a system using LiDAR and a camera, for example.

### TECHNICAL FIELD

The present technology relates to an information processing apparatus, an information processing method, and a program, and particularly relates to, for example, an information processing apparatus, an information processing method, and a program that are suitable for use in a case where calibration of a positional relationship between a three-dimensional sensor and a camera is performed.

### BACKGROUND ART

At present, a sensing technology using a camera and light detection and ranging (LiDAR) has been developed and spread.

For example, in an automated driving technology, a sensor fusion technology that simultaneously uses a camera and LiDAR is used.

For example, a sensing technology using a camera and LiDAR is used in a background asset generation technology in a metaverse or a movie. For example, in the background asset generation technology, a three-dimensional structure of space is generated with high accuracy using LiDAR, and colorization processing is performed using camera images, thereby constructing a realistic space that is different from computer graphics (CG).

In order to improve the accuracy and quality of these technologies, the calibration of the positional relationship between the camera and the LiDAR is performed. That is, a parameter indicating the positional relationship between the camera and the LiDAR is corrected (adjusted).

For example, calibration is performed using a dedicated inspection jig such as a chart or a board (for example, refer to Patent Document 1).

For example, movement amounts respectively calculated by the camera and the LiDAR are compared, and calibration is performed on the basis of a difference between the movement amounts (for example, refer to Patent Document 2).

### CITATION LIST

### Patent Document

Patent Document 1: Japanese Patent Application Laid-Open No. 2021-38939
Patent Document 2: WO 2022/190169 A

### SUMMARY OF THE INVENTION

### Problems to be Solved by the Invention

However, in a case where inspection jigs are used, for example, when a positional deviation occurs between sensors after the shipment of a vehicle using the sensor fusion technology, it is difficult to perform calibration. Furthermore, for example, in the background asset generation technology, it is necessary to capture a scene including the inspection jig and to capture only the background without the inspection jig.

In a case where the calibration is performed on the basis of the difference in the movement amounts between sensors, the accuracy of the calibration depends on the detection accuracy of the movement amount of the sensor. Furthermore, in a case where the sensor is fixed and is not moved as in the background asset generation technology, it is difficult to perform calibration.

The present technology has been made in view of such circumstances, and enables calibration of the positional relationship between a three-dimensional sensor such as LiDAR and a camera to be easily executed with high accuracy.

### Solutions to Problems

An information processing apparatus according to an aspect of the present technology includes an irradiation control unit that controls an irradiation timing of measurement light of a three-dimensional sensor; a corresponding point detection unit that detects, in a camera image acquired by a camera, a corresponding point that corresponds to an observation point detected using the measurement light by the three-dimensional sensor; and a correction unit that corrects a parameter indicating a positional relationship between the LiDAR and the camera on the basis of a position of the observation point in a predetermined three-dimensional coordinate system and a position of the corresponding point in a two-dimensional coordinate system of the camera image.

An information processing method according to another aspect of the present technology includes controlling an irradiation timing of measurement light of a three-dimensional sensor; detecting, in a camera image acquired by a camera, a corresponding point that corresponds to an observation point detected using the measurement light by the three-dimensional sensor; and correcting a parameter indicating a positional relationship between the LiDAR and the camera on the basis of a position of the observation point in a predetermined three-dimensional coordinate system and a position of the corresponding point in a two-dimensional coordinate system of the camera image.

A program according to another aspect of the present technology causes a computer to execute processing of controlling an irradiation timing of measurement light of a three-dimensional sensor; detecting, in a camera image acquired by a camera, a corresponding point that corresponds to an observation point detected using the measurement light by the three-dimensional sensor; and correcting a parameter indicating a positional relationship between the LiDAR and the camera on the basis of a position of the observation point in a predetermined three-dimensional coordinate system and a position of the corresponding point in a two-dimensional coordinate system of the camera image.

In the aspects of the present technology, an irradiation timing of measurement light of a three-dimensional sensor is controlled; in a camera image acquired by a camera, a corresponding point that corresponds to an observation point detected using the measurement light by the three-dimensional sensor is detected; and a parameter indicating a positional relationship between the LiDAR and the camera is corrected on the basis of a position of the observation point in a predetermined three-dimensional coordinate system and a position of the corresponding point in a two-dimensional coordinate system of the camera image.

### BRIEF DESCRIPTION OF DRAWINGS

FIG. 1 is a block diagram illustrating a first embodiment of an information processing system to which the present technology is applied.

FIG. 2 is a block diagram illustrating a first embodiment of a data processing apparatus in FIG. 1.

FIG. 3 is a block diagram illustrating a configuration example of functions implemented by a processor in FIG. 2.

FIG. 4 is a flowchart for describing a first embodiment of calibration processing.

FIG. 5 is a flowchart for describing a first embodiment of observation point/corresponding point detection processing.

FIG. 6 is a flowchart for describing a first embodiment of positional relationship information correction processing.

FIG. 7 is a block diagram illustrating a second embodiment of the data processing apparatus in FIG. 1.

FIG. 8 is a block diagram illustrating a configuration example of functions implemented by a processor in FIG. 7.

FIG. 9 is a flowchart for describing a second embodiment of calibration processing.

FIG. 10 is a block diagram illustrating a second embodiment of the information processing system to which the present technology is applied.

FIG. 11 is a block diagram illustrating a configuration example of the data processing apparatus in FIG. 10.

FIG. 12 is a flowchart for describing a second embodiment of observation point/corresponding point detection processing.

FIG. 13 is a flowchart for describing a second embodiment of positional relationship information correction processing.

FIG. 14 is a block diagram illustrating a modification example of an information processing system to which the present technology is applied.

FIG. 15 is a block diagram illustrating a configuration example of a computer.

### MODE FOR CARRYING OUT THE INVENTION

Hereinafter, modes for carrying out the present technology will be described. The description will be given in the following order.
1. First Embodiment
2. Second Embodiment (Example of Checking Positional Deviation)
3. Third Embodiment (Example Using Event-base Vision Sensor (EVS))
4. Modification Example
5. Others

### 1. First Embodiment

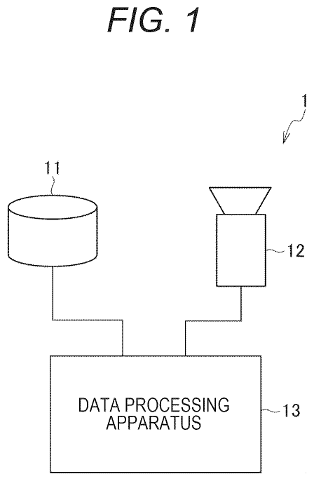

First, a first embodiment of the present technology will be described with reference to FIGS. 1 to 6.

### <Configuration Example of Vehicle Control System>

FIG. 1 illustrates a configuration example of an information processing system 1 to which the present technology is applied.

For example, the information processing system 1 is applied to systems or apparatuses that use a sensing technology employing LiDAR 11 and a camera 12, such as an automated driving technology and a background asset generation technology. The information processing system 1 includes the LiDAR 11, the camera 12, and a data processing apparatus 13.

As the LiDAR 11, a type of LiDAR that performs scanning with measurement light including pulsed laser light (laser pulse) within a predetermined field of view (FOV) (hereinafter, referred to as the LiDAR FOV) is used. Specifically, for example, the LiDAR 11 employs a mechanical rotation type LiDAR including a drive motor, or a solid-state type LiDAR such as a Micro Electro Mechanical Systems (MEMS) mirror type.

Note that a type of LiDAR that does not perform scanning with the measurement light (for example, a flash type) is not used in the LiDAR 11.

The LiDAR 11 performs scanning with the measurement light within the LiDAR FOV, and detects the position (coordinates) of each point (hereinafter, referred to as an observation point) in a predetermined three-dimensional coordinate system (hereinafter, referred to as a LiDAR coordinate system), the point being detected by the reflection of the measurement light from an object within the LiDAR FOV. The LiDAR 11 generates a point cloud (point group data) indicating a distribution of the observation points in the LiDAR coordinate system, and supplies the point cloud to the data processing apparatus 13. Furthermore, the LiDAR 11 can also generate information (hereinafter, referred to as observation point information) including individual detection positions of each observation point in the LiDAR coordinate system, and supply the information to the data processing apparatus 13.

Note that, as the LiDAR coordinate system, a global coordinate system or a coordinate system dedicated to the LiDAR 11 may be used.

The camera 12 captures images within a predetermined FOV (hereinafter, referred to as camera FOV). The camera FOV at least partially overlaps with the LiDAR FOV. The camera 12 supplies data (hereinafter, referred to as camera image data) indicating an image (hereinafter, referred to as a camera image) obtained as a result of the imaging to the data processing apparatus 13.

The data processing apparatus 13 executes various kinds of data processing on the basis of the point cloud and the camera image data. For example, the data processing apparatus 13 executes object detection processing, object recognition processing, object motion prediction processing, background asset generation processing, and the like.

Furthermore, the data processing apparatus 13 also executes calibration of the positional relationship between the LiDAR 11 and the camera 12 on the basis of the observation point information and the camera image data. That is, the data processing apparatus 13 executes processing to correct (adjust) a parameter indicating the positional relationship (relative position and pose) between the LiDAR 11 and the camera 12. Note that the calibration of the positional relationship between the LiDAR 11 and the camera 12 may simply be referred to as the calibration of the LiDAR 11 and the camera 12, in some cases.

<Configuration Example of Data Processing Apparatus 13a>

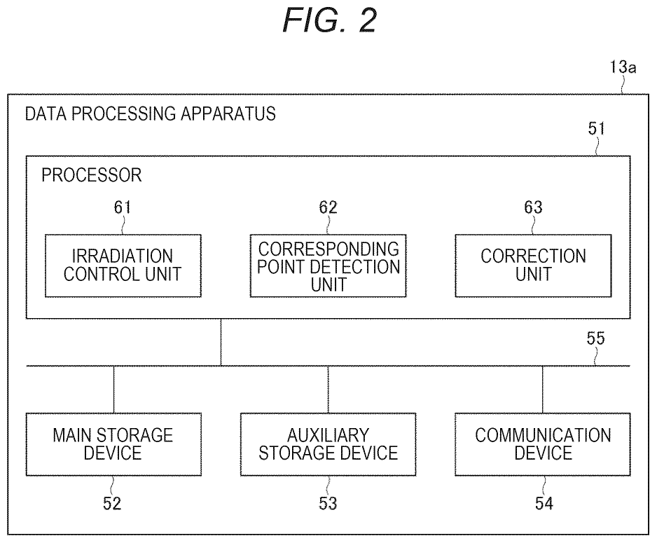

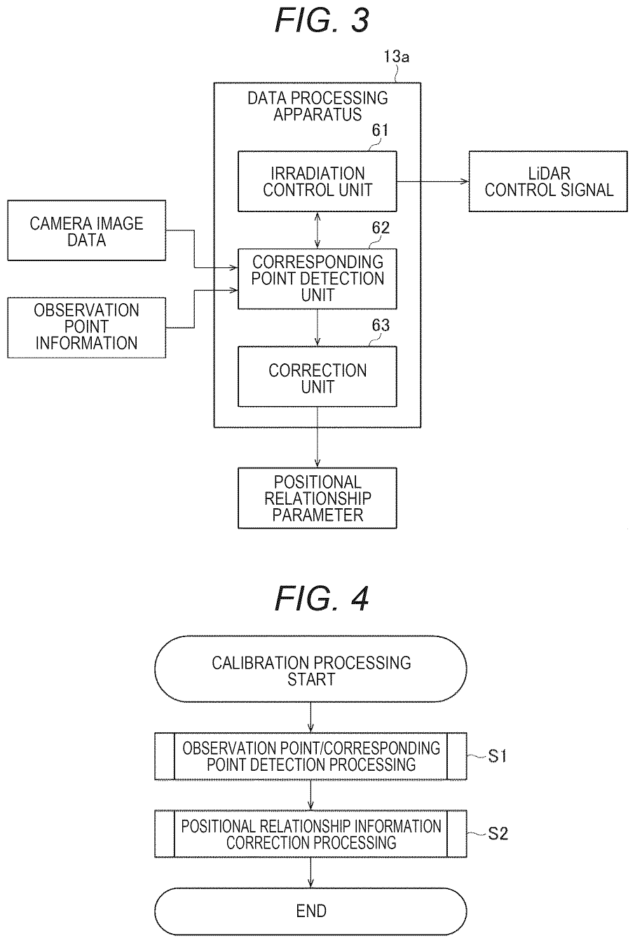

Next, with reference to FIGS. 2 and 3, a configuration example of a data processing apparatus 13a, which is the first embodiment of the data processing apparatus 13 in FIG. 1, will be described. FIG. 2 illustrates a configuration example of the data processing apparatus 13a. FIG. 3 illustrates a configuration example of functions implemented by a processor 51 of the data processing apparatus 13a.

The data processing apparatus 13 includes the processor 51, a main storage device 52, an auxiliary storage device 53, and a communication device 54. The processor 51, the main storage device 52, the auxiliary storage device 53, and the communication device 54 are connected to one another via a bus 55.

The processor 51 includes, for example, a central processing unit (CPU), a digital signal processor (DSP), and the like.

The main storage device 52 includes, for example, a random access memory (RAM), and the like.

The auxiliary storage device 53 includes, for example, a hard disk drive (HDD), a flash memory, a solid state drive (SSD), and the like.

The communication device 54 includes, for example, an electric circuit or the like having a communication function. The communication device 54 performs communication with external apparatuses such as the LiDAR 11 and the camera 12. The communication method employed by the communication device 54 may be either wireless communication or wired communication.

The processor 51 loads a program stored in the auxiliary storage device 53 into the main storage device 52, and executes the program to implement functions including an irradiation control unit 61, a corresponding point detection unit 62, and a correction unit 63.

Note that only the functions of executing processing related to the calibration of the LiDAR 11 and the camera 12 are illustrated here, and the illustration of functions of executing other processing is omitted.

The irradiation control unit 61 controls the emission of the measurement light of the LiDAR 11 by supplying a LiDAR control signal to the LiDAR 11 via the bus 55 and the communication device 54. For example, the irradiation control unit 61 controls an irradiation direction, an irradiation timing, and the like of the measurement light of the LiDAR 11. Furthermore, the irradiation control unit 61 also notifies the corresponding point detection unit 62 of the irradiation direction, the irradiation timing, and the like of the measurement light by supplying the LiDAR control signal to the corresponding point detection unit 62.

The corresponding point detection unit 62 executes processing to detect, in the camera image, a corresponding point that corresponds to the observation point of the LiDAR 11, on the basis of the observation point information from the LiDAR 11 and the camera image data from the camera 12. The corresponding point detection unit 62 supplies observation point/corresponding point information indicating detection results of the observation point and the corresponding point, to the correction unit 63. Furthermore, the corresponding point detection unit 62 also instructs the irradiation control unit 61 to irradiate the measurement light in a case where the detection processing of the corresponding point is performed.

The correction unit 63 corrects the parameters indicating the positional relationship between the LiDAR 11 and the camera 12 on the basis of the observation point/corresponding point information. The correction unit 63 outputs the positional relationship information including the corrected parameters.

Note that hereinafter, the description “via the bus 55” in a case where each unit of the data processing apparatus 13a performs transmission, reception, and the like of data via the bus 55 will be omitted. For example, a case where the irradiation control unit 61 and the main storage device 52 perform transmission and reception of data via the bus 55 is simply described that the irradiation control unit 61 and the main storage device 52 perform transmission and reception of data. Furthermore, hereinafter, the description “via the bus 55 and the communication device” in a case where each unit of the data processing apparatus 13a performs communication with the outside via the bus 55 and the communication device 54 will be omitted. For example, a case where the irradiation control unit 61 performs communication with the LiDAR 11 via the bus 55 and the communication device 54 is simply described that the irradiation control unit 61 performs communication with the LiDAR 11. These also apply in a similar manner to other embodiments.

### <Calibration Processing>

Next, with reference to the flowchart in FIG. 4, the calibration processing executed by the information processing system 1 will be described.

In step S1, the information processing system 1 executes observation point/corresponding point detection processing.

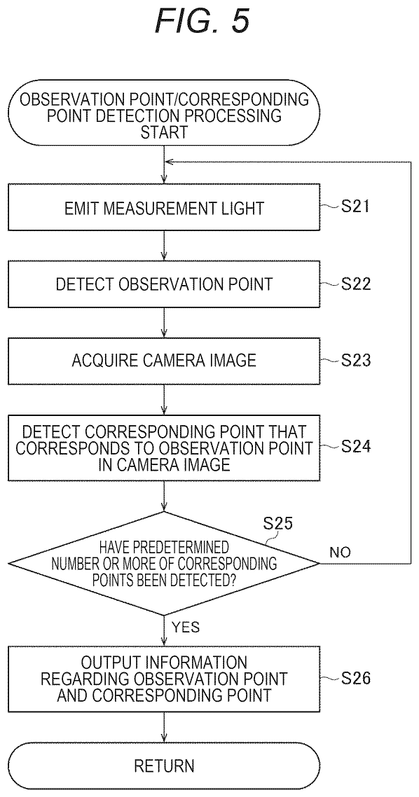

Here, details of the observation point/corresponding point detection processing will be described with reference to the flowchart in FIG. 5.

In step S21, the LiDAR 11 emits the measurement light under the control of the irradiation control unit 61. Specifically, the corresponding point detection unit 62 instructs the irradiation control unit 61 to perform the irradiation with the measurement light. The irradiation control unit 61 supplies the LiDAR control signal to the LiDAR 11 and the corresponding point detection unit 62. The LiDAR 11 emits the measurement light on the basis of the LiDAR control signal.

Here, the irradiation direction of the measurement light is set to a different direction each time the processing of step S21 is performed. For example, the irradiation direction of the measurement light may be moved according to a scanning order during normal operation (for example, during point cloud creation), or may be moved in a manner different from that during the normal operation.

Furthermore, the irradiation timing of the measurement light is controlled such that the measurement light is emitted at most once during each exposure period of the camera 12. Accordingly, the irradiation frequency of the measurement light of the LiDAR 11 becomes equal to or lower than a frame rate of the camera 12. In other words, an irradiation interval of the measurement light of the LiDAR 11 becomes equal to or longer than a frame interval (exposure interval) of the camera 12.

In step S22, the LiDAR 11 detects the observation point. Specifically, the LiDAR 11 detects the position of the observation point, which is detected by the reflection of the measurement light emitted in the processing of step S21, in the LiDAR coordinate system. The LiDAR 11 generates observation point information including the detection position of the observation point, and supplies the observation point information to the processor 51.

In step S23, the camera 12 acquires a camera image. Specifically, the camera 12 images the inside of the camera FOV. At this time, as described above, the LiDAR 11 emits the measurement light during the exposure period of the camera 12. The camera 12 supplies camera image data obtained by imaging the inside of the camera FOV, to the processor 51.

In step S24, the corresponding point detection unit 62 detects a corresponding point that corresponds to the observation point in the camera image.

Here, in the camera image, a region corresponding to the observation point, that is, a region where the measurement light is reflected is assumed to have high brightness. On the other hand, for example, the corresponding point detection unit 62 detects, as a corresponding point, a pixel having the maximum brightness in the camera image.

Note that, for example, due to a factor such as a point that is assumed to be an observation point appearing blurred in the camera image, simply detecting a pixel having the maximum brightness as the corresponding point may lead to erroneous detection of the corresponding point.

On the other hand, for example, the corresponding point detection unit 62 may apply Non Maximum Suppression (NMS) to pixels having brightness equal to or greater than a predetermined threshold value, in the camera image, and detect the pixel having the maximum brightness among those pixels, as the corresponding point.

Furthermore, for example, the corresponding point detection unit 62 may detect pixels having brightness equal to or greater than a predetermined threshold value, in the camera image as the corresponding points. In this case, a plurality of corresponding points may be detected from a single camera image, or no corresponding point may be detected.

Note that, for example, the corresponding point detection unit 62 may apply NMS to pixels having the brightness equal to or greater than a predetermined threshold value, in the camera image, and detect the pixel having brightness equal to or greater than the predetermined threshold value among those pixels, as the corresponding point.

In step S25, the corresponding point detection unit 62 determines whether or not a predetermined number or more of corresponding points have been detected. In a case where it is determined that the predetermined number or more of corresponding points have not yet been detected, the processing returns to step S21.

Thereafter, the processing of steps S21 to S25 is repeatedly executed until it is determined in step S25 that the predetermined number or more of corresponding points have been detected. Therefore, a plurality of corresponding points, which corresponds to a plurality of observation points detected using the measurement light emitted at different irradiation timings, is detected in different camera images. Furthermore, a predetermined number or more of pairs of observation points and corresponding points (hereinafter, referred to as an observation point/corresponding point pair) are detected.

On the other hand, in a case where it is determined in step S25 that the predetermined number or more of corresponding points have been detected, the processing proceeds to step S26.

In step S26, the corresponding point detection unit 62 outputs information regarding the observation points and the corresponding points. Specifically, the corresponding point detection unit 62 generates observation point/corresponding point information indicating the detection results of the observation point and the corresponding point. The observation point/corresponding point information includes, for example, position information of each observation point/corresponding point pair. The position information of each observation point/corresponding point pair includes identification information (for example, an image ID of the camera image in which the corresponding point is detected) for identifying each pair, the position (coordinates) of the observation point in the LiDAR coordinate system, and the position (coordinates) of the corresponding point in a two-dimensional coordinate system (hereinafter, referred to as a camera image coordinate system) of the camera image. The corresponding point detection unit 62 supplies the observation point/corresponding point information to the correction unit 63.

Thereafter, the observation point/corresponding point detection processing ends.

Returning to FIG. 4, in step S2, the data processing apparatus 13 executes the positional relationship information correction processing, and the calibration processing ends.

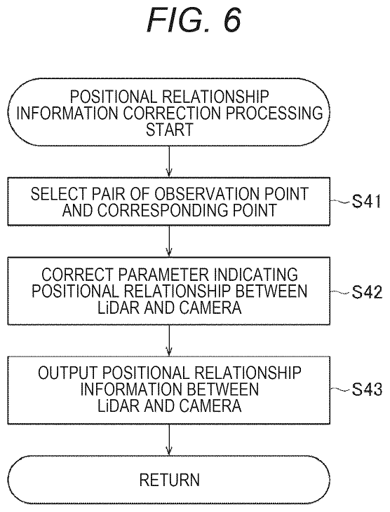

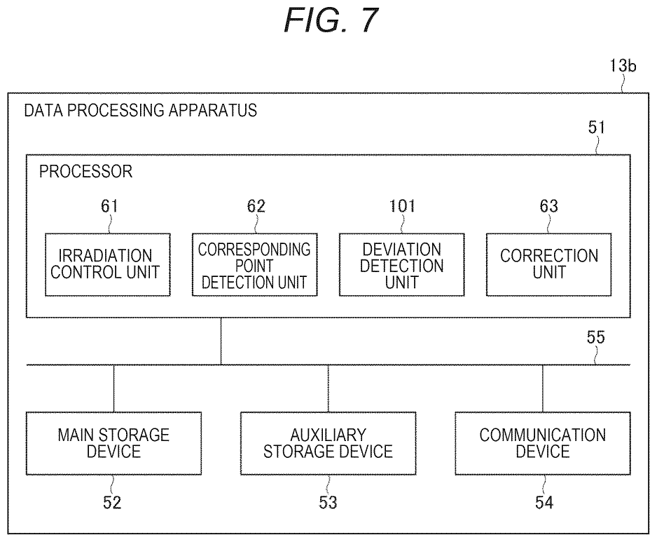

Here, with reference to the flowchart in FIG. 6, details of the positional relationship information correction processing will be described.

In step S41, the correction unit 63 selects a pair of the observation point and the corresponding point.

Here, among the corresponding points detected in the camera image, there is a possibility that a pixel that does not actually correspond to the observation point is erroneously detected.

On the other hand, the correction unit 63 selects observation point/corresponding point pairs by performing, for example, inlier estimation using RANdom SAmple Consensus (RANSAC), and removes the pair including the corresponding point that is estimated to be erroneously detected.

Specifically, for example, the correction unit 63 selects three sets of observation point/corresponding point pairs from among the observation point/corresponding point pairs included in the observation point/corresponding point information. Here, in a case where a plurality of corresponding points is detected in one camera image, the three sets of observation point/corresponding point pairs are selected such that pairs including corresponding points detected in the same camera image are not included simultaneously. That is, three sets of observation point/corresponding point pairs, which respectively include corresponding points detected in different camera images, are selected.

The correction unit 63 estimates the position and pose of the camera 12 in the LiDAR coordinate system by solving P3P using the selected three sets of observation point/corresponding point pairs. The correction unit 63 projects each observation point included in the observation point/corresponding point information onto the camera image coordinate system on the basis of the estimated position and pose of the camera 12. The correction unit 63 calculates a positional error (reprojection error) between a projection point, which is obtained by projecting each observation point onto the camera image coordinate system, and the corresponding point (the corresponding point included in the same observation point/corresponding point pair) that corresponds to each observation point. The correction unit 63 extracts an observation point/corresponding point pair of which the reprojection error is equal to or less than a threshold value, and counts the number of the extracted observation point/corresponding point pairs.

For example, the correction unit 63 executes the above-described processing for combinations of three sets of observation point/corresponding point pairs selected from at least a predetermined number of such pairs, and detects the combination of the observation point/corresponding point pairs in which the number of corresponding points with a reprojection error equal to or less than the threshold value is maximized.

Note that the above-described processing may be executed for all combinations of three sets of observation point/corresponding point pairs, excluding combinations that simultaneously include pairs including the corresponding points detected in the same camera image, and the combination of observation point/corresponding point pairs in which the number of corresponding points with a reprojection error equal to or less than the threshold value is maximized may be detected.

Hereinafter, the combination of observation point/corresponding point pairs in which the number of observation point/corresponding point pairs with a reprojection error equal to or less than the threshold value is maximized is referred to as an optimal combination of observation point/corresponding point pairs. Furthermore, the position and pose of the camera 12 estimated on the basis of the optimal combination of observation point/corresponding point pairs are referred to as a provisional position and a provisional pose of the camera 12.

The correction unit 63 extracts an observation point/corresponding point pair with the reprojection error equal to or less than the threshold value, in the provisional position and provisional pose of the camera 12. Furthermore, the correction unit 63 removes pairs other than the extracted observation point/corresponding point pairs from the observation point/corresponding point information. Therefore, the observation point/corresponding point pair including the corresponding point that is likely to be erroneously detected is removed from the observation point/corresponding point information.

In step S42, the correction unit 63 corrects the parameters indicating the positional relationship between the LiDAR 11 and the camera 12. For example, the correction unit 63 optimizes the parameter indicating the position and pose of the camera 12 in the LiDAR coordinate system by solving PnP using the observation point/corresponding point pairs extracted in the processing of step S41.

Specifically, the correction unit 63 projects each observation point of the observation point/corresponding point pair extracted in the processing of step S41 onto the camera image coordinate system on the basis of the provisional position and provisional pose of the camera 12 based on the optimal combination of observation point/corresponding point pairs. The correction unit 63 corrects the parameter indicating the position and pose of the camera 12 in the LiDAR coordinate system such that the sum or average value of the errors (reprojection errors) between the projection points obtained by projecting each observation point onto the camera image coordinate system and the corresponding points that correspond to the respective observation points is minimized.

The correction unit 63 corrects the parameters indicating the positional relationship between the LiDAR 11 and the camera 12 on the basis of the position and pose of the camera 12 in the LiDAR coordinate system after the correction.

The types of parameters indicating the positional relationship between the LiDAR 11 and the camera 12 are not particularly limited. For example, the parameters indicating the positional relationship between the LiDAR 11 and the camera 12 may include the parameter indicating the position and pose of the camera 12 in the LiDAR coordinate system. For example, the parameters indicating the positional relationship between the LiDAR 11 and the camera 12 may include a translation matrix and a rotation matrix indicating the relative position and pose of the LiDAR 11 and the camera 12. For example, the parameters indicating the positional relationship between the LiDAR 11 and the camera 12 may include a transformation matrix used for the conversion between the LiDAR coordinate system and the camera image coordinate system.

The correction unit 63 generates the positional relationship information including the corrected parameters indicating the positional relationship between the LiDAR 11 and the camera 12.

In step S43, the correction unit 63 outputs the positional relationship information between the LiDAR 11 and the camera 12. For example, the correction unit 63 outputs the positional relationship information, and stores the positional relationship information in the main storage device 52 or the auxiliary storage device 53.

The positional relationship information stored in the main storage device 52 or the auxiliary storage device 53 is appropriately used in subsequent processing.

Thereafter, the positional relationship information correction processing ends.

As described above, the calibration of the positional relationship between the LiDAR 11 and the camera 12 can be easily executed with high accuracy. That is, without using inspection jigs or moving the LiDAR 11 or the camera 12, the calibration of the positional relationship between the LiDAR 11 and the camera 12 can be directly executed with high accuracy.

### 2. Second Embodiment

Next, a second embodiment of the present technology will be described with reference to FIGS. 7 to 9.

<Configuration Example of Data Processing Apparatus 13b>

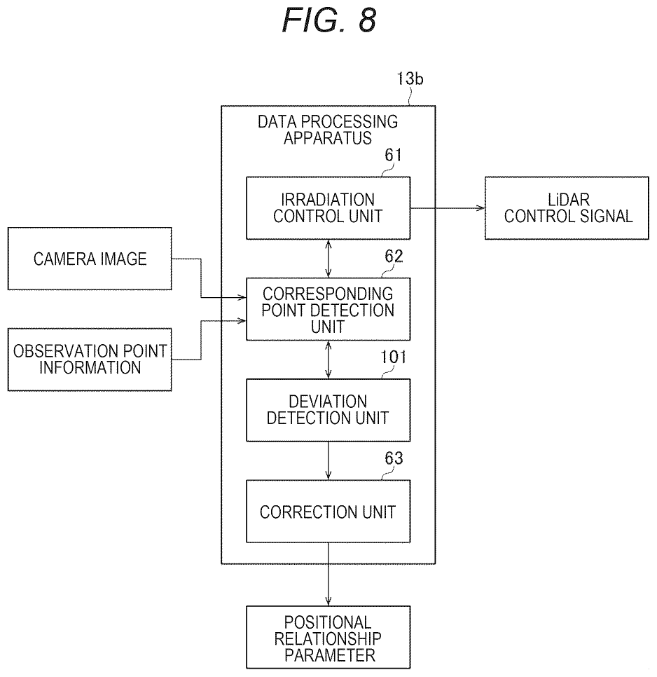

First, with reference to FIGS. 7 and 8, a configuration example of a data processing apparatus 13b, which is the second embodiment of the data processing apparatus 13 in FIG. 1, will be described. FIG. 7 illustrates a configuration example of the data processing apparatus 13b. FIG. 8 illustrates a configuration example of functions implemented by the processor 51 of the data processing apparatus 13b.

Note that, in the drawing, portions corresponding to those in FIGS. 2 and 3 are given the same reference numerals, and description thereof is omitted as appropriate.

A hardware configuration of the data processing apparatus 13b is similar to the hardware configuration of the data processing apparatus 13a in FIG. 2.

On the other hand, the functions realized by the processor 51 of the data processing apparatus 13b are different from the functions realized by the processor 51 of the data processing apparatus 13a in that a deviation detection unit 101 is added.

Note that only the functions of executing processing related to the calibration of the LiDAR 11 and the camera 12 are illustrated here, and the illustration of functions of executing other processing is omitted.

The corresponding point detection unit 62 supplies the observation point/corresponding point information indicating the detection results of the observation point and the corresponding point, to the deviation detection unit 101.

The deviation detection unit 101 checks for a physical positional deviation between the LiDAR 11 and the camera 12 on the basis of the observation point/corresponding point information. In a case where the deviation detection unit 101 has detected a positional deviation between the LiDAR 11 and the camera 12, the deviation detection unit 101 supplies the observation point/corresponding point information to the correction unit 63, and instructs the correction of the positional relationship information between the LiDAR 11 and the camera 12. Furthermore, the deviation detection unit 101 also instructs the corresponding point detection unit 62 to detect a corresponding point in a case where the positional deviation between the LiDAR 11 and the camera 12 is checked for.

### <Calibration Processing>

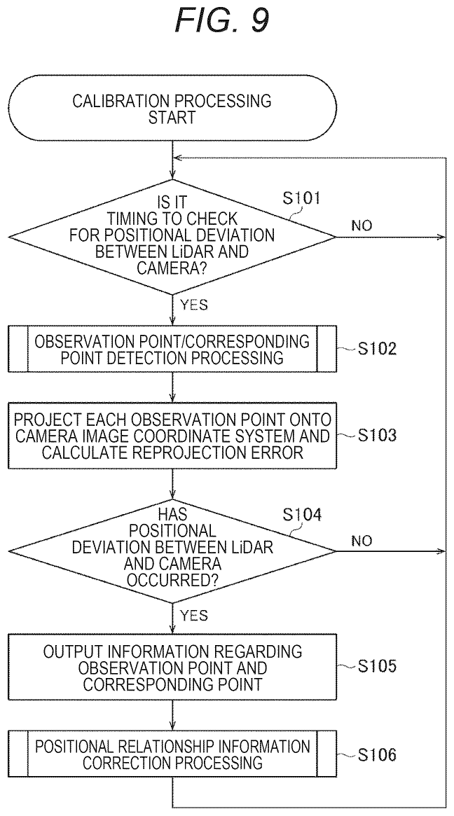

Next, with reference to the flowchart in FIG. 9, the calibration processing executed by the information processing system 1 including the data processing apparatus 13b will be described.

In step S101, the deviation detection unit 101 determines whether or not it is a timing to check for a positional deviation between the LiDAR 11 and the camera 12. The determination processing of step S101 is repeatedly executed until it is determined that it is a timing to check for a positional deviation between the LiDAR 11 and the camera 12.

On the other hand, in a case where it is determined that it is a timing to check for a positional deviation between the LiDAR 11 and the camera 12, the deviation detection unit 101 instructs the corresponding point detection unit 62 to detect a corresponding point. Thereafter, the processing proceeds to step S102.

Note that the timing to check for a positional deviation between the LiDAR 11 and the camera 12 can be arbitrarily set. For example, checking for the positional deviation may be executed at a predetermined interval or at a predetermined time period. For example, checking for the positional deviation may be executed in a case where a predetermined condition is satisfied. Specifically, for example, in a case where a result of the subsequent processing deteriorates (for example, in a case where the accuracy or confidence level of the object detection processing, the object recognition processing, or the object motion prediction processing becomes less than a predetermined threshold value), checking for the positional deviation may be executed. For example, in a case where the information processing system 1 is installed in a vehicle, checking for the positional deviation may be executed at the time of departure, stop, or the like of the vehicle.

In step S102, the observation point/corresponding point detection processing is executed in a manner similar to the processing of step S1 in FIG. 4. Note that, in this processing, the observation point/corresponding point information generated by the corresponding point detection unit 62 is supplied to the deviation detection unit 101.

In step S103, the deviation detection unit 101 projects each observation point onto the camera image coordinate system, and calculates a reprojection error. Specifically, the deviation detection unit 101 projects each observation point onto the camera image coordinate system on the basis of the parameter indicating the current positional relationship between the LiDAR 11 and the camera 12. The deviation detection unit 101 calculates a positional error (reprojection error) between the projection point, which is obtained by projecting each observation point onto the camera image coordinate system, and the corresponding point that corresponds to each observation point.

In step S104, the deviation detection unit 101 determines whether or not a positional deviation has occurred between the LiDAR 11 and the camera 12. First, the deviation detection unit 101 selects a projection point/corresponding point pair. Specifically, the deviation detection unit 101 removes the projection point/corresponding point pair of which the reprojection error calculated in the processing of step S103 is equal to or greater than a predetermined threshold value. Therefore, the corresponding point/projection point pair that is likely to be erroneously detected is removed.

The deviation detection unit 101 calculates a statistical value (for example, an average value or a maximum value) of the reprojection errors of the remaining projection point/corresponding point pairs. In a case where the statistical value of the reprojection errors is less than the predetermined threshold value, the deviation detection unit 101 determines that no positional deviation has occurred between the LiDAR 11 and the camera 12, and the processing returns to step S101.

Thereafter, the processing of steps S101 to S104 is repeatedly executed until it is determined in step S104 that a positional deviation has occurred between the LiDAR 11 and the camera 12.

On the other hand, in a case where the statistical value of the reprojection errors is equal to or greater than the predetermined threshold value, the deviation detection unit 101 determines in step S104 that a positional deviation has occurred between the LiDAR 11 and the camera 12, and the processing proceeds to step S105.

In step S105, the deviation detection unit 101 outputs information regarding the observation points and the corresponding points. Specifically, the deviation detection unit 101 removes the observation point/corresponding point pair removed in the processing of step S104, from the observation point/corresponding point information. That is, the observation point/corresponding point pair including the corresponding point that is likely to be erroneously detected is removed. The deviation detection unit 101 supplies the observation point/corresponding point information including the remaining observation point/corresponding point pairs to the correction unit 63.

In step S106, the positional relationship information correction processing is executed in a manner similar to the processing of step S2 in FIG. 4.

Thereafter, the processing returns to step S101, and the processing of step S101 and subsequent steps is performed.

As described above, a positional deviation between the LiDAR 11 and the camera 12 can be automatically detected, and calibration of the positional relationship between the LiDAR 11 and the camera 12 can be executed. Therefore, for example, even in a case where the LiDAR 11 and the camera 12 are installed on a mobile object such as a vehicle and a positional deviation is likely to occur, the parameters indicating the positional relationship between the LiDAR 11 and the camera 12 can be maintained with high accuracy.

### 3. Third Embodiment

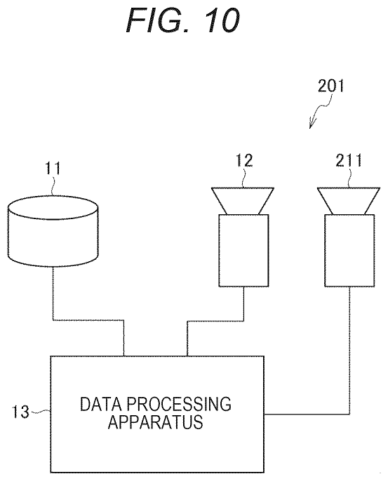

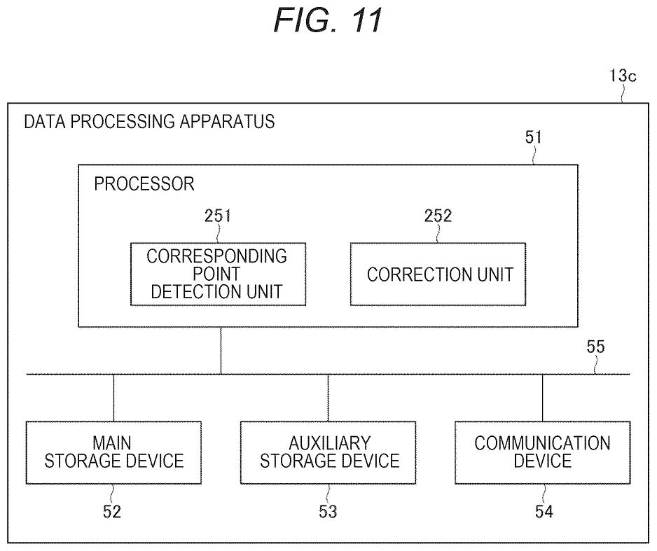

Next, a third embodiment of the present technology will be described with reference to FIGS. 10 to 13.

### <Configuration Example of Information Processing System 201>

FIG. 10 illustrates a configuration example of an information processing system 201 to which the present technology is applied. Note that, in the drawing, portions corresponding to those of the information processing system 1 in FIG. 1 are given the same reference numerals, and description thereof is omitted as appropriate.

The information processing system 201 differs from the information processing system 1 in that an EVS 211 is added.

The EVS 211 supplies, to the data processing apparatus 13, a signal (hereinafter, referred to as a response point signal) indicating a position of a pixel (hereinafter, referred to as a response point) of which the brightness has been changed by a value equal to or greater than a predetermined threshold value, a detection time point of a response point, and a polarity of a response point.

Note that the position of the response point is indicated by coordinates in a two-dimensional coordinate system (hereinafter, referred to as an EVS image coordinate system) of an image (hereinafter, referred to as an EVS image) generated by the EVS 211. The polarity of the response point indicates whether the brightness of the response point is changed in the positive or negative direction.

Hereinafter, it is assumed that calibration of the positional relationship between the camera 12 and the EVS 211 is executed in advance, and that the parameters indicating the positional relationship between the camera 12 and the EVS 211 are acquired in advance.

<Configuration Example of Data Processing Apparatus 13c>

FIG. 11 illustrates a configuration example of a data processing apparatus 13c used in the information processing system 201 in FIG. 10, which is a third embodiment of the data processing apparatus 13 in FIG. 1. Note that, in the drawing, portions corresponding to those in FIG. 2 are given the same reference numerals, and description thereof is omitted as appropriate.

A hardware configuration of the data processing apparatus 13c is similar to the hardware configuration of the data processing apparatus 13a in FIG. 2.

The processor 51 loads a program stored in the auxiliary storage device 53 into the main storage device 52, and executes the program to implement functions including a corresponding point detection unit 251 and a correction unit 252.

Note that only the functions of executing processing related to the calibration of the LiDAR 11 and the camera 12 are illustrated here, and the illustration of functions of executing other processing is omitted.

The corresponding point detection unit 251 executes processing to detect a corresponding point that is a response point corresponding to the observation point of the LiDAR 11, on the basis of the observation point information from the LiDAR 11 and the response point signal from the EVS 211. The corresponding point detection unit 251 supplies observation point/corresponding point information indicating detection results of the observation point and the corresponding point, to the correction unit 252.

The correction unit 252 corrects the parameters indicating the positional relationship between the LiDAR 11 and the EVS 211 on the basis of the observation point/corresponding point information. Moreover, the correction unit 252 corrects parameters indicating the positional relationship between the LiDAR 11 and the camera 12 on the basis of the corrected parameters indicating the positional relationship between the LiDAR 11 and the EVS 211 and the known parameters indicating the positional relationship between the camera 12 and the EVS 211. The correction unit 252 outputs the positional relationship information including the corrected parameters.

### <Calibration Processing>

Next, with reference to the flowchart in FIG. 4 described above, the calibration processing executed by the information processing system 201 will be described.

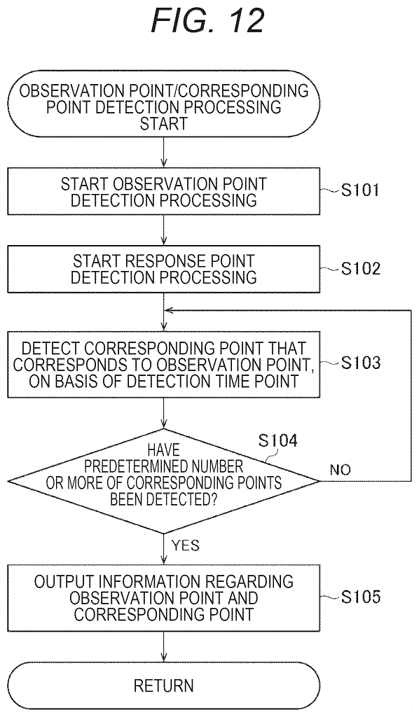

In step S1, the information processing system 201 executes observation point/corresponding point detection processing. Here, details of the observation point/corresponding point detection processing will be described with reference to the flowchart in FIG. 12.

In step S101, the LiDAR 11 starts the observation point detection processing. Specifically, the LiDAR 11 starts scanning the measurement light and detecting the position of the observation point, which is detected by the reflection of the measurement light, in the LiDAR coordinate system. The scanning of the measurement light at this time does not need to be synchronized with the camera 12 and the EVS 211, and may be performed in a manner similar to that during the normal operation (for example, during point cloud creation). Furthermore, the LiDAR 11 starts processing to generate observation point information including the detection position and detection time point of the observation point and to supply the observation point information to the processor 51.

In step S102, the EVS 211 starts the response point detection processing. Specifically, the EVS 211 starts processing to detect the response point, to generate a response point detection signal indicating the position of the response point in the EVS image coordinate system, the detection time point of the response point, and the polarity of the response point, and to supply the response point detection signal to the processor 51.

In step S103, the corresponding point detection unit 251 detects a corresponding point that corresponds to the observation point, on the basis of the detection time point. Specifically, the corresponding point detection unit 251 detects the response point that is detected at approximately the same time point as the observation point, as the corresponding point that corresponds to the observation point, on the basis of the observation point information and the response point signal.

In step S104, the corresponding point detection unit 251 determines whether or not a predetermined number or more of corresponding points have been detected. In a case where it is determined that the predetermined number or more of corresponding points have not yet been detected, the processing returns to step S103.

Thereafter, the processing of steps S103 and S104 is repeatedly executed until it is determined in step S104 that the predetermined number or more of corresponding points have been detected. Therefore, a predetermined number or more of pairs of observation points and corresponding points are detected.

On the other hand, in a case where it is determined in step S104 that the predetermined number or more of corresponding points have been detected, the processing proceeds to step S105.

In step S105, the corresponding point detection unit 251 outputs information regarding the observation points and the corresponding points. Specifically, the corresponding point detection unit 251 generates observation point/corresponding point information indicating the detection results of the observation point and the corresponding point. The observation point/corresponding point information includes, for example, position information of each observation point/corresponding point pair. The position information of each observation point/corresponding point pair includes identification information for identifying each pair, the position of the observation point in the LiDAR coordinate system, and the position of the corresponding point in the EVS image coordinate system. The corresponding point detection unit 251 supplies the observation point/corresponding point information to the correction unit 252.

Thereafter, the observation point/corresponding point detection processing ends.

Returning to FIG. 4, the data processing apparatus 13c executes the positional relationship information correction processing.

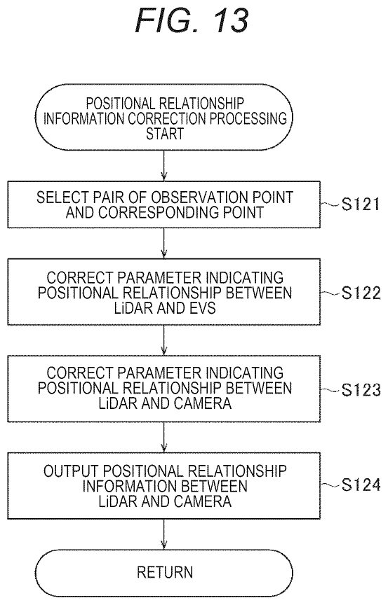

Here, with reference to the flowchart in FIG. 13, details of the positional relationship information correction processing will be described.

In step S121, pairs of the observation points and the corresponding points are selected through the processing similar to that of step S41 in FIG. 6. Here, the coordinate system of the corresponding points differs in that the camera image coordinate system is used in the processing of step S41 whereas the EVS image coordinate system is used in the processing of step S121, but pairs of the observation points and the corresponding points can be selected through the similar processing.

In step S122, parameters indicating the positional relationship between the LiDAR 12 and the EVS 211 are corrected through the processing similar to that of step S42 in FIG. 6. Here, the calibration target differs in that the target is the camera 12 in the processing of step S42 whereas the target is the EVS 211 in the processing of step S122, but the parameters indicating the positional relationship between the LiDAR 12 and the EVS 211 can be corrected through the similar processing.

In step S123, the correction unit 252 corrects the parameters indicating the positional relationship between the LIDAR 11 and the camera 12. For example, the correction unit 252 corrects a parameter P_{lc} indicating the positional relationship between the LiDAR 11 and the camera 12 on the basis of a parameter Pₗₑ indicating the positional relationship between the LiDAR 11 and the EVS 211, which is corrected in the processing of step S122, and the known parameter P_{ec} indicating the positional relationship between the EVS 211 and the camera 12, using following Expression (1).

$${P}_{lc} = {P}_{le} \times {P}_{ec} \qquad ( 1 )$$

The correction unit 252 generates the positional relationship information including the corrected parameters indicating the positional relationship between the LiDAR 11 and the camera 12.

In step S124, the positional relationship information between the LiDAR 11 and the camera 12 is output in a manner similar to that of the processing of step S43 in FIG. 6.

Thereafter, the positional relationship information correction processing ends.

As described above, the calibration of the positional relationship between the LiDAR 11 and the camera 12 is executed in a state where the LiDAR 11 independently performs scanning with the measurement light in a manner similar to that during the normal operation. Therefore, it becomes possible to detect the corresponding points at high speed, and the processing time for the calibration of the positional relationship between the LiDAR 11 and the camera 12 is shortened.

### 4. Modification Example

Hereinafter, modification examples of the above-described embodiments of the present technology will be described.

For example, the corresponding point detection unit 62 may use a difference image in order to improve the detection accuracy of the corresponding point. For example, the corresponding point detection unit 62 may generate a difference image by taking the difference between a camera image captured in a state where the measurement light is being emitted and a camera image captured in a state where the measurement light is not being emitted, and may detect the corresponding point on the basis of the difference image.

In this case, the corresponding point detection unit 62 may apply NMS to pixels having brightness equal to or greater than a predetermined threshold value, in the difference image, and detect the pixel having the maximum brightness or the pixel having brightness equal to or greater than the predetermined threshold value among those pixels, as the corresponding point.

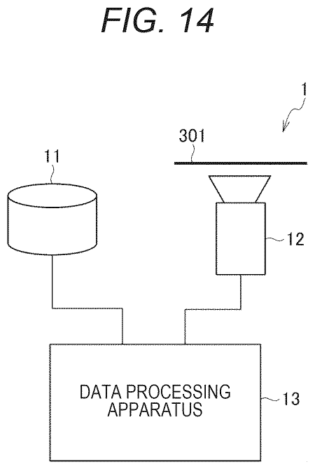

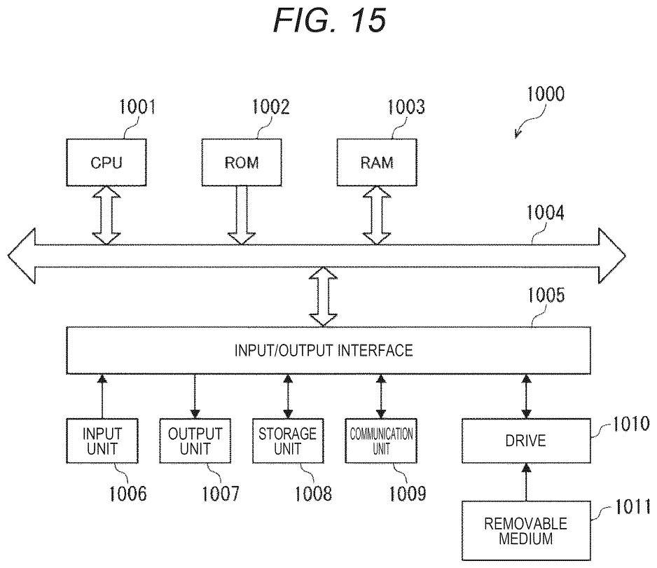

For example, as illustrated in FIG. 14, in order to improve the detection accuracy of the corresponding points, an optical filter 301 that transmits only wavelengths near that of the measurement light may be provided to cover a lens portion of the camera 12. The optical filter 301 may be installed only during calibration, for example.

For example, in the processing of step S41 in FIG. 6, the correction unit 63 may select n sets of observation point/corresponding point pairs (where n is 4 or more), estimate the position and pose of the camera 12 in the LiDAR coordinate system by solving PnP, and calculate the reprojection error.

For example, in a case where the information processing system 1 is mounted on a mobile object such as a vehicle and the calibration of the positional relationship between the LiDAR 11 and the camera 12 is executed during the movement of the mobile object, it is not necessarily required to change the irradiation direction of the measurement light from the LiDAR 11.

For example, the present technology is applicable not only to the LiDAR 11 but also to other three-dimensional sensors that perform scanning with the measurement light and detect the distribution (three-dimensional information) of the observation points in the three-dimensional coordinate system.

The types of cameras to which the present technology is applicable are not particularly limited. For example, the present technology can also be applicable to cameras that can detect wavelength bands other than visible light or cameras that can detect depth information.

### 5. Others

### <Configuration Example of Computer>

The above-described series of processing can be executed by hardware and can also be executed by software. In a case where the series of processing is executed by software, a program constituting the software is installed in a computer. Here, examples of the computer include a computer incorporated in dedicated hardware, and for example, a general-purpose personal computer that can execute various functions by installing various programs.

FIG. 15 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are mutually connected via a bus 1004.

Moreover, an input/output interface 1005 is connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, or the like. The output unit 1007 includes a display, a speaker, or the like. The storage unit 1008 includes a hard disk, a nonvolatile memory, or the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, the series of processing described above is performed by the CPU 1001 loading, for example, a program stored in the storage unit 1008 into the RAM 1003 via the input/output interface 1005 and the bus 1004 and executing the program.

The program executed by the computer 1000 (CPU 1001) can be provided by being recorded in the removable medium 1011 as a package medium or the like, for example. Furthermore, the program can be provided via a wired or wireless transmission medium such as a local area network, the Internet, or digital satellite broadcasting.

In the computer 1000, the program can be installed in the storage unit 1008 via the input/output interface 1005 by mounting the removable medium 1011 on the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program in which processing is performed in time series in the order described in the present specification, or may be a program in which processing is performed in parallel or at necessary timing such as when a call is made.

Furthermore, in the present specification, a system means a set of a plurality of constituent elements (apparatuses, modules (components), and the like), and it does not matter whether or not all the constituent elements are in the same housing. Therefore, a plurality of apparatuses housed in separate housings and connected via a network and one apparatus in which a plurality of modules is housed in one housing are both systems.

Moreover, the embodiments of the present technology are not limited to the above-described embodiments, and various changes can be made without departing from the gist of the present technology.

For example, the present technology can have a configuration of cloud computing in which one function is shared and processed in cooperation by a plurality of apparatuses via a network.

Furthermore, each step described in the flowchart described above can be executed by one apparatus or can be shared and executed by a plurality of apparatuses.

Moreover, in a case where a plurality of kinds of processing is included in one step, the plurality of kinds of processing included in the one step can be executed by one apparatus or can be shared and executed by a plurality of apparatuses.

### <Combination Example of Configuration>

The present technology can also have the following configurations.

(1)

An information processing apparatus including:
an irradiation control unit that controls an irradiation timing of measurement light of a three-dimensional sensor;
a corresponding point detection unit that detects, in a camera image acquired by a camera, a corresponding point that corresponds to an observation point detected using the measurement light by the three-dimensional sensor; and
a correction unit that corrects a parameter indicating a positional relationship between the three-dimensional sensor and the camera on the basis of a position of the observation point in a predetermined three-dimensional coordinate system and a position of the corresponding point in a two-dimensional coordinate system of the camera image.
   (2)

The information processing apparatus according to (1),
in which the irradiation control unit controls the irradiation timing such that an interval at which the measurement light is emitted is equal to or greater than a frame interval of the camera.
   (3)

The information processing apparatus according to (2),
in which the irradiation control unit controls the irradiation timing such that the measurement light is emitted during an exposure period of the camera.
   (4)

The information processing apparatus according to any one of (1) to (3),
in which the irradiation control unit further controls an irradiation direction of the measurement light.
   (5)

The information processing apparatus according to any one of (1) to (4),
in which the corresponding point detection unit detects a plurality of corresponding points that corresponds to a plurality of observation points detected using the measurement light emitted at different irradiation timings, in different camera images, and
the correction unit corrects the parameter on the basis of a plurality of pairs of the observation points and the corresponding points.
   (6)

The information processing apparatus according to (5),
in which the correction unit selects the pairs on the basis of a reprojection error that is a positional error between a projection point, which is obtained by projecting the observation point onto the two-dimensional coordinate system, and the corresponding point, and corrects the parameter on the basis of the extracted pairs.
   (7)

The information processing apparatus according to (6),
in which the correction unit selects the pair on the basis of the reprojection error based on a position and a pose of the camera estimated on the basis of three or more pairs selected from the plurality of pairs.
   (8)

The information processing apparatus according to any one of (1) to (7), further including:
a positional deviation detection unit that checks for a positional deviation between the three-dimensional sensor and the camera on the basis of a detection result of the observation point and the corresponding point,
in which the correction unit corrects the parameter in a case where the positional deviation is detected.
   (9)

The information processing apparatus according to (8),
in which the positional deviation detection unit checks for the positional deviation on the basis of a reprojection error that is a positional error between a projection point, which is obtained by projecting the observation point onto the two-dimensional coordinate system on the basis of the parameter, and the corresponding point.
   (10)

The information processing apparatus according to (9),
in which the corresponding point detection unit detects a plurality of corresponding points that corresponds to a plurality of observation points detected using the measurement light emitted at different irradiation timings, in different camera images, and
the positional deviation detection unit checks for the positional deviation on the basis of a plurality of pairs of the observation points and the corresponding points.
   (11)

The information processing apparatus according to (10),
in which the correction unit selects the pairs on the basis of the reprojection error, and corrects the positional deviation on the basis of the reprojection error of the extracted pairs.
   (12)

The information processing apparatus according to any one of (1) to (11),
in which the corresponding point detection unit detects the corresponding point on the basis of brightness of the camera image.
   (13)

The information processing apparatus according to (12),
in which the corresponding point detection unit applies Non Maximum Suppression (NMS) to a pixel having brightness equal to or greater than a predetermined threshold value, in the camera image, and then detects the corresponding point.
   (14)

The information processing apparatus according to (12) or (13),
in which the corresponding point detection unit detects the corresponding point on the basis of a difference image between the camera image captured in a state where the measurement light is emitted and the camera image captured in a state where the measurement light is not emitted.
   (15)

The information processing apparatus according to any one of (1) to (14),
in which the three-dimensional sensor is Light Detection And Ranging (LiDAR).
   (16)

An information processing method including:
controlling an irradiation timing of measurement light of a three-dimensional sensor;
detecting, in a camera image acquired by a camera, a corresponding point that corresponds to an observation point detected using the measurement light by the three-dimensional sensor; and
correcting a parameter indicating a positional relationship between the three-dimensional sensor and the camera on the basis of a position of the observation point in a predetermined three-dimensional coordinate system and a position of the corresponding point in a two-dimensional coordinate system of the camera image.
   (17)

A program for causing a computer to execute processing of:
controlling an irradiation timing of measurement light of a three-dimensional sensor;
detecting, in a camera image acquired by a camera, a corresponding point that corresponds to an observation point detected using the measurement light by the three-dimensional sensor; and
correcting a parameter indicating a positional relationship between the three-dimensional sensor and the camera on the basis of a position of the observation point in a predetermined three-dimensional coordinate system and a position of the corresponding point in a two-dimensional coordinate system of the camera image.

Note that the effects described in the present specification are merely examples and are not limited, and other effects may be provided.

### REFERENCE SIGNS LIST

1 Information processing system
11 LiDAR
12 Camera
13, 13a, 13b, 13c Data processing apparatus
51 Processor
61 Irradiation control unit
62 Corresponding point detection unit
63 Correction unit
101 Deviation detection unit
201 Information processing system
251 Corresponding point detection unit
252 Correction unit

1. An information processing apparatus comprising:
an irradiation control unit that controls an irradiation timing of measurement light of a three-dimensional sensor;
a corresponding point detection unit that detects, in a camera image acquired by a camera, a corresponding point that corresponds to an observation point detected using the measurement light by the three-dimensional sensor; and
a correction unit that corrects a parameter indicating a positional relationship between the three-dimensional sensor and the camera on a basis of a position of the observation point in a predetermined three-dimensional coordinate system and a position of the corresponding point in a two-dimensional coordinate system of the camera image.

2. The information processing apparatus according to claim 1,
wherein the irradiation control unit controls the irradiation timing such that an interval at which the measurement light is emitted is equal to or greater than a frame interval of the camera.

3. The information processing apparatus according to claim 2,
wherein the irradiation control unit controls the irradiation timing such that the measurement light is emitted during an exposure period of the camera.

4. The information processing apparatus according to claim 1,
wherein the irradiation control unit further controls an irradiation direction of the measurement light.

5. The information processing apparatus according to claim 1,
wherein the corresponding point detection unit detects a plurality of corresponding points that corresponds to a plurality of observation points detected using the measurement light emitted at different irradiation timings, in different camera images, and
the correction unit corrects the parameter on a basis of a plurality of pairs of the observation points and the corresponding points.

6. The information processing apparatus according to claim 5,
wherein the correction unit selects the pairs on a basis of a reprojection error that is a positional error between a projection point, which is obtained by projecting the observation point onto the two-dimensional coordinate system, and the corresponding point, and corrects the parameter on a basis of the extracted pairs.

7. The information processing apparatus according to claim 6,
wherein the correction unit selects the pairs on a basis of the reprojection error based on a position and a pose of the camera estimated on a basis of three or more pairs selected from the plurality of pairs.

8. The information processing apparatus according to claim 1, further comprising:
a positional deviation detection unit that checks for a positional deviation between the three-dimensional sensor and the camera on a basis of a detection result of the observation point and the corresponding point,
wherein the correction unit corrects the parameter in a case where the positional deviation is detected.

9. The information processing apparatus according to claim 8,
wherein the positional deviation detection unit checks for the positional deviation on a basis of a reprojection error that is a positional error between a projection point, which is obtained by projecting the observation point onto the two-dimensional coordinate system on a basis of the parameter, and the corresponding point.

10. The information processing apparatus according to claim 9,
wherein the corresponding point detection unit detects a plurality of corresponding points that corresponds to a plurality of observation points detected using the measurement light emitted at different irradiation timings, in different camera images, and
the positional deviation detection unit checks for the positional deviation on a basis of a plurality of pairs of the observation points and the corresponding points.

11. The information processing apparatus according to claim 10,
wherein the correction unit selects the pairs on a basis of the reprojection error, and corrects the positional deviation on a basis of the reprojection error of the extracted pairs.

12. The information processing apparatus according to claim 1,
wherein the corresponding point detection unit detects the corresponding point on a basis of brightness of the camera image.

13. The information processing apparatus according to claim 12,
wherein the corresponding point detection unit applies Non Maximum Suppression (NMS) to a pixel having brightness equal to or greater than a predetermined threshold value, in the camera image, and then detects the corresponding point.

14. The information processing apparatus according to claim 12,
wherein the corresponding point detection unit detects the corresponding point on a basis of a difference image between the camera image captured in a state where the measurement light is emitted and the camera image captured in a state where the measurement light is not emitted.

15. The information processing apparatus according to claim 1,
wherein the three-dimensional sensor is Light Detection And Ranging (LiDAR).

16. An information processing method comprising:
controlling an irradiation timing of measurement light of a three-dimensional sensor;
detecting, in a camera image acquired by a camera, a corresponding point that corresponds to an observation point detected using the measurement light by the three-dimensional sensor; and
correcting a parameter indicating a positional relationship between the three-dimensional sensor and the camera on a basis of a position of the observation point in a predetermined three-dimensional coordinate system and a position of the corresponding point in a two-dimensional coordinate system of the camera image.

17. A program for causing a computer to execute processing of:
controlling an irradiation timing of measurement light of a three-dimensional sensor;
detecting, in a camera image acquired by a camera, a corresponding point that corresponds to an observation point detected using the measurement light by the three-dimensional sensor; and
correcting a parameter indicating a positional relationship between the three-dimensional sensor and the camera on a basis of a position of the observation point in a predetermined three-dimensional coordinate system and a position of the corresponding point in a two-dimensional coordinate system of the camera image.
